(19) United States
(12) Patent Application Publication
(10) Pub. No.: US 2018/0241135 A1
(43) Pub. Date: Aug. 23, 2018

(54) 27-28.5 GHz Ka BAND PHASED ARRAY FAN BEAM ANTENNAS AND METHODS

(71) Applicant: TAOGLAS GROUP HOLDINGS LIMITED, Enniscorthy (IE)

(72) Inventors: Vladimir FURLAN, Munich (DE); Patrick Carl Frank, Farmington, MN (US)

(21) Appl. No.: 15/903,485

(22) Filed: Feb. 23, 2018

Related U.S. Application Data
(60) Provisional application No. 62/462,480, filed on Feb. 23, 2017.

(51) Int. Cl. H01Q 21/06; H01Q 3/26; H01Q 13/20; H01Q 15/24

(52) U.S. Cl. CPC H01Q 21/065; H01Q 15/244; H01Q 13/206; H01Q 3/2658

(57) ABSTRACT

The disclosed 20 dBi KSF300. A high gain 5th generation mobile network or wireless system (5G) technology fan beam antenna array offers a wide 3 dB beamwidth for wide angular coverage in azimuth with most of the energy focused within 44° of the main beam. Since propagation losses at Ka band are 20× more than at 6 GHz, the beamwidth of the antenna is reduced when the antenna gain increases. To alleviate this problem, the fan-beam type antenna can be useful to provide simultaneously high gain and wide azimuth coverage.

### CROSS-REFERENCE

This application claims the benefit of U.S. Provisional Application No. 62/462,480, filed Feb. 23, 2017, entitled 27-28.5 GHz Ka Band Phased Array Fan Beam Antenna, which application is incorporated herein by reference.

### BACKGROUND

### Field

The present disclosure relates in general to an antenna and, in particular, to a phased-array antenna.

### Background

5th generation (5G) mobile or wireless networks will support 1,000-fold gains in capacity, connections for at least 100 billion devices, and a 10 GB individual user experience capable of extremely low latency and response times. Deployment of these networks will begin circa 2020. 5G radio access will be built upon both new radio access technologies and evolved existing wireless technologies.

Phased array antennas are composed of a plurality of radiating elements each with a phase shifter. Beams are formed by shifting the phase of the signal emitted from each radiating element, to shift the radiation pattern to the desired direction, thus providing wider coverage than similar non-phase shifted antennas. They are expected to find wide deployment in 5G radio systems due to their combination of high gain and low power requirements. As such, substantial research and development effort is being directed toward phased array antenna technologies.

What is needed are 5G-ready phased array antennas with multi-phase capability, simultaneous high gain and wide angular coverage in the azimuth, and high cross polarization rejection. Additional benefits would be realized if such antenna systems combined small form factor and low mass for easy integration into numerous different devices.

### SUMMARY

Disclosed are linear-patch, phased array, fan beam antenna devices with linear polarization. The disclosure provides 10 dB bandwidth across 27 GHz-28.5 GHz, with a 20 dBi effective peak gain across a 16×1 element array. The antenna array can be inside a Ka-band 5G access point and has a minimum 1 GHz impedance bandwidth which is suitable for fixed and mobile broadband capacity. The antennas feature over 23 dB cross pol rejection which makes the antenna array less susceptible to interference from other signals. The 3 dB beam width of the disclosed systems deliver wide angular coverage in azimuth with most of the energy focused within 44° of the main beam. In addition, the disclosed antennas provides greater than 20 dB cross-polarization rejection, reducing susceptibility to interference. The design of the antennas intrinsically allow for the cross-polarization rejection.

An aspect of the disclosure is directed to 27.5-28.5 GHz Ka band phased array fan beam antennas. Suitable antennas comprise: a substrate; a first antenna patch connected to a second antenna patch by a first micro-strip feed line to form a first antenna patch pair; a third antenna patch connected to a fourth antenna patch by a second micro-strip feed line to form a second antenna patch pair; a fifth antenna patch connected to a sixth antenna patch by a third micro-strip feed line to form a third antenna patch pair; a seventh antenna patch connected to an eighth antenna patch by a fourth micro-strip feed line to form a fourth antenna patch pair; and an output port or integrated circuit, wherein the first antenna patch pair is connected to the second antenna patch to form a first antenna patch quad via a first micro-strip quad connector and the third antenna patch pair is connected to the fourth antenna patch pair to form a second antenna patch quad via a second micro-strip quad connector, and further wherein the first micro-strip quad connector and the second micro-strip quad connector are connected to the output port or integrated circuit. Additionally, the 27.5-28.5 GHz Ka band phased array fan beam antennas can further comprise: a ninth antenna patch connected to a tenth antenna patch by a fifth micro-strip feed line to form a fifth antenna patch pair; an eleventh antenna patch connected to a twelfth antenna patch by a sixth micro-strip feed line to form a sixth antenna patch pair; a thirteenth antenna patch connected to a fourteenth antenna patch by a seventh micro-strip feed line to form a seventh antenna patch pair; a fifteenth antenna patch connected to a sixteenth antenna patch by an eighth micro-strip feed line to form an eighth antenna patch pair, wherein the fifth antenna patch pair is connected to the sixth antenna patch to form a third antenna patch quad via a third micro-strip quad connector and the seventh antenna patch pair is connected to the eighth antenna patch pair to form a fourth antenna patch quad via a forth micro-strip quad connector, and further wherein the third micro-strip quad connector and the fourth micro-strip quad connector are connected to the output port or integrated circuit. In at least some configurations, one or more of the first patch antenna, second patch antenna, third patch antenna, fourth patch antenna, fifth patch antenna, sixth patch antenna, seventh patch antenna and eight patch antenna have a shape selected from square, round, rectangular, oval, ovoid and triangular. Additionally, one or more of the ninth patch antenna, tenth patch antenna, eleventh patch antenna, twelfth patch antenna, thirteenth patch antenna, fourteenth patch antenna, fifteenth patch antenna and sixteenth patch antenna have a shape selected from square, round, rectangular, oval, ovoid and triangular. One or more of the any of the micro-strip feed lines and/or quad-connectors, including but not limited to micro-strip feed lines one through fifteen can have a shape selected from U-shaped, V-shaped and forked and further comprise a connector. Any of the one or more of the micro-strip feed lines can further have a pair of phase-shifting components integrated therein.

Another aspect of the disclosure is directed to methods of generating a 27.5-28.5 GHz Ka band phased array from fan beam antennas. Suitable methods comprise: providing a substrate with a plurality of antenna patches connected by a plurality of feed lines forming a feed network; feeding a signal of a different phase to at least one of the plurality of antenna patches; and creating a broad radiation pattern with a high gain in a first plane and a narrow radiation in a second plane orthogonal to the first plane. In some embodiments, the fan beam antenna further comprises sixteen antenna patches. Additionally the antenna patches can be connected in pairs or quads by one or more traces or feed lines. Additionally, pairs and quads can further be connected by one or more traces or feed lines. The antenna patches can be connected directly or indirectly to one or more integrated circuits and/or one or more output ports.

Still another aspect of the disclosure is directed to 27.5-28.5 GHz Ka band phased array fan beam antennas. Suitable antennas comprise: a substrate; a plurality of antenna patches, a plurality of micro-strip feed lines; and at least one of an output port and at least one integrated circuit, wherein the plurality of micro-strip feed lines connect one or more of the plurality of antenna patches to at least one of another antenna patch, the output port and the integrated circuit. In at least some configurations, one or more of the plurality of patch antennas has a shape selected from square, round, rectangular, oval, ovoid and triangular. Additionally, the one or more of the plurality of micro-strip feed lines can have a shape selected from U-shaped, V-shaped and forked and further comprises a connector. One or more of the plurality of micro-strip feed lines can further be configurable to have a pair of phase-shifting components integrated therein.

### INCORPORATION BY REFERENCE

All publications, patents, and patent applications mentioned in this specification are herein incorporated by reference to the same extent as if each individual publication, patent, or patent application was specifically and individually indicated to be incorporated by reference:
KONISHI et al., “Fan-beam forming for a linear antenna with exponential-tapered amplitude distribution,” published in the Transaction of the Institute of Electronics, Information and Communication Engineers B-II 79-.3:192-9. Inst. Electron. Inf. & Comm. Eng. (March 1996);
LIN et al., “Integrated Filtering Microstrip Duplex antenna Array with High Isolation,” Hindawi, International Journal of Antennas and Propagation, Volume 2017 (Feb. 22, 2017);
NORDIN et al. “24 GHz Patch Antenna Array Design for RADAR,” Lund University, Jun. 29, 2016;
ZHANG et al., “An optically controlled phased array antenna based on single sideband polarization modulation,” Optics Express pp. 3761-3765, published Feb. 24, 2014;
ZORNICA et al., “Folded Multilayer Microstrip Reflectarray With Shaped Pattern,” IEEE Transactions on Antennas and Propagation, Vol. 54, No. 2, February 2006;
US 2013/0300602 A1 published Nov. 14, 2013 by Zhou et al.;
U.S. Pat. No. 5,115,248 A issued May 19, 1992 by Roederer;
U.S. Pat. No. 5,166,693 A issued Nov. 24, 1992 by Nishikawa et al.;
U.S. Pat. No. 6,492,943 B1 issued Dec. 10, 2002 by Marumoto et al.;
U.S. Pat. No. 6,545,647 B1 issued Apr. 8, 2003 by Sievenpiper et al.;
U.S. Pat. No. 7,123,943 B2 issued Oct. 17, 2006 by Ylitalo;
U.S. Pat. No. 7,250,908 A1 issued Nov. 17, 2005 by Lee et al.;
U.S. Pat. No. 7,498,999 B2 issued Mar. 3, 2009 by Shtrom;
U.S. Pat. No. 7,532,171 B2 issued May 12, 2009 by Chandler; and
WO 2012/093392 A1 published Jul. 12, 2012 by Milano et al.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A illustrates a top view of an antenna array according to the disclosure;

FIG. 1B illustrates a top view of a ground plane layer according to the disclosure;

FIG. 2A illustrates a top view of an alternative embodiment of an antenna array according to the disclosure;

FIG. 2B illustrates a top view of an alternative embodiment of an antenna array according to the disclosure;

FIG. 2C illustrates a top view of an alternative embodiment of an antenna array according to the disclosure;

FIG. 3 is a plot of simulated return loss of an antenna system according to the disclosure;

FIG. 4 is a plot of simulated voltage standing wave radio (VSWR) of an antenna system according to the disclosure;

FIG. 5 is a plot of the simulated efficiency of an antenna system according to the disclosure;

FIG. 6 is a plot of the simulated peak gain of an antenna system according to the disclosure;

FIG. 7 is a plot of the simulated average gain of an antenna system according to the disclosure;

FIG. 8 is a three-dimensional plot of simulated radiation pattern of an antenna system according to the disclosure;

FIG. 9 is a three-dimensional plot of simulated radiation pattern at a 75 degree phase shift of an antenna system according to the disclosure;

FIG. 10 is a three-dimensional plot of simulated radiation pattern at a 45 degree phase shift of an antenna system according to the disclosure;

FIG. 11 is a three-dimensional plot of simulated radiation pattern at a 15 degree phase shift of an antenna system according to the disclosure;

FIG. 12 is a three-dimensional plot of simulated radiation pattern at a 0 degree phase shift of an antenna system according to the disclosure;

FIG. 13 is a three-dimensional plot of simulated radiation pattern at a −15 degree phase shift of an antenna system according to the disclosure;

FIG. 14 is a three-dimensional plot of simulated radiation pattern at a −45 degree phase shift of an antenna system according to the disclosure; and

FIG. 15 is a three-dimensional plot of simulated radiation pattern at a −75 degree phase shift of an antenna system according to the disclosure.

### DETAILED DESCRIPTION

Disclosed is a linear-patch, phased array, fan beam antenna device with linear polarization. The disclosed antenna configuration provides 10 dB bandwidth across about 27.5 GHz-28.5 GHz, with a 20 dBi effective peak gain across a 16×1 element array. The 3 dB beam width of the disclosed antenna system delivers wide angular coverage in azimuth with most of the energy focused within 44° of the main beam. In addition, the disclosed antenna configuration provides greater than 20 dB cross-polarization rejection, reducing the antenna's susceptibility to interference.

To overcome the narrow bandwidth in the orthogonal plane that is typical of patch antennas, the feed network of the disclosed system is designed so that phase-shifting components may be integrated in any of the feed lines. This allows each patch antenna in the antenna array to potentially be fed by a signal of a different phase; alternately patch antennas in the antenna array may be grouped (e.g., in pairs, quads or pairs of quads), and each antenna group to be fed by a signal with a different phase. This enables creation of a broad combined radiation pattern with relatively high gain, resulting in effective coverage. The phased array design has a wide radiation pattern in a first plane and a narrow radiation pattern in a second plane that is orthogonal to the first plane. The phase array design enables reliable signal-tracking and reduces the need for high signal power.

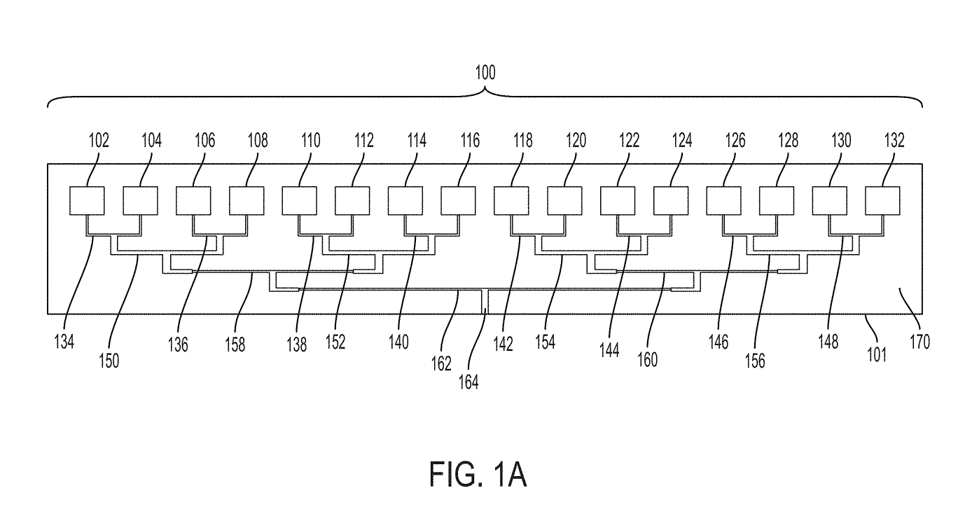

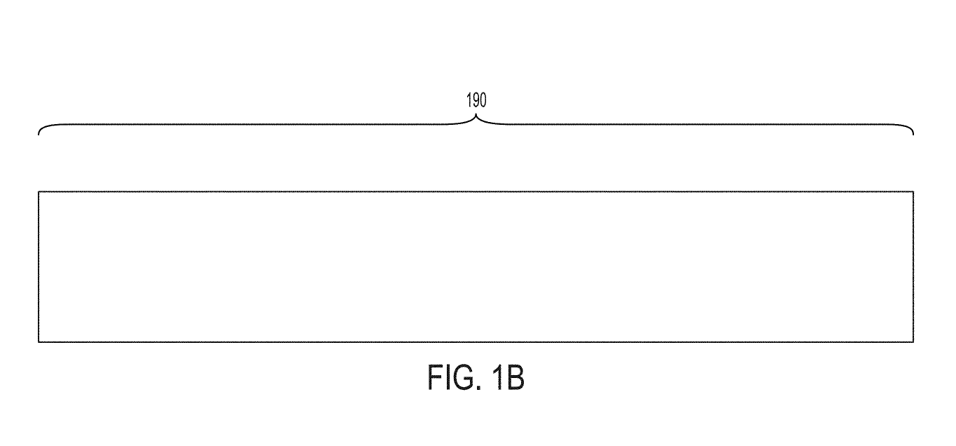

FIG. 1A illustrates an antenna assembly 100 according to the disclosure, viewed from above. The antenna assembly 100 comprises the following main components: a dielectric substrate 101, a plurality of patch antennas, a plurality of micro-strip feed lines connecting various patch antennas to a single output; and a ground plane layer. Each of the micro-strip feed lines can have a pair of phase-shifting components. Dielectric substrate 101 is formed from a suitable dielectric material; is planar or substantially planar; and can measure from about 80 mm to about 130 mm, more preferably about 108 mm in a first dimension and from about 14 mm to about 22 mm in a second dimension, more preferably about 18 mm. The dielectric substrate 101 can have a thickness of 0.15 mm to about 0.35 mm, more preferably 0.25 mm.

Residing upon the top surface 170 of dielectric substrate 101, are a plurality of patch antennas. The patch antennas are illustrated as having a perimeter shape of substantially square. However, as will be appreciated by those skilled in the art, other shapes of the patch antenna can be used without departing from the scope of the disclosure including, but not limited to: square, rectangular, round, oval, ovoid, and triangular. Any number of patches, odd or even, can be used without departing from the scope of the disclosure. Additionally, the patch antennas can include further components including, but not limited to, for example microstrip transmission line(s), microstrip antenna, and a substrate.

The patch antennas can further be organized into pairs of patch antennas and pairs of antennas into quads of patch antennas. The quads of patch antennas can be paired so that eight patch antennas are connected by nested traces which connect two antennas or two pairs of antenna groups (e.g., quads or quad pairs). The patch antennas are depicted as square elements. However, as will be appreciated by those skilled in the art, other shapes and configurations can be used without departing from the scope of the disclosure. Additionally, the embodiments have been illustrated with sixteen patch antennas. More or fewer than sixteen antennas can be used without departing from the scope of the disclosure. Additionally, the number of total antenna patches can be odd or event and antenna patch multiples, pairs and groups can be two or more antenna patches.

FIG. 1A illustrates first antenna patch 102, second antenna patch 104, third antenna patch 106, fourth antenna patch 108, fifth antenna patch 110, sixth antenna patch 112, seventh antenna patch 114, eighth antenna patch 116, ninth antenna patch 118, tenth antenna patch 120, eleventh antenna patch 122, twelfth antenna patch 124, thirteenth antenna patch 126, fourteenth antenna patch 128, fifteenth antenna patch 130, and sixteenth antenna patch 132 (alternatively identified as first antenna patch through sixteenth antenna patch). These patch antennas are illustrated as positioned substantially linearly along the long dimension of dielectric substrate 101 and numbered sequentially from left to right when viewed from above as depicted in FIG. 1A. As will be appreciated by those skilled in the art, the plurality of patch antennas need not be on a single line, as illustrated. The patch antennas can be aligned so that the antennas, or pairs of antennas have different centerlines across the same axis in order to have a staggered position on the dielectric substrate 101.

First antenna patch 102, and second antenna patch 104 comprise a first pair of antenna patches. Third antenna patch 106, and fourth antenna patch 108 comprise a second pair of antenna patches. Fifth antenna patch 110, and sixth antenna patch 112 comprise a third pair of antenna patches. Seventh antenna patch 114, and eighth antenna patch 116 comprise a fourth pair of antenna patches. Ninth antenna patch 118, and tenth antenna patch 120 comprise a fifth pair of antenna patches. Eleventh antenna patch 122, and twelfth antenna patch 124 comprise a sixth pair of antenna patches. Thirteenth antenna patch 126 and fourteenth antenna patch 128 comprise a seventh pair of antenna patches. Fifteenth antenna patch 130, and sixteenth antenna patch 132 comprise an eighth pair of antenna patches.

First micro-strip feed line 134 connects first antenna patch 102 and second antenna patch 104 which are the first antenna patch pair. Second micro-strip feed line 136 connects the third antenna patch 106 and the fourth antenna patch 108 which are the second antenna patch pair. Third micro-strip feed line 138 connects the fifth antenna patch 110 and the sixth antenna patch 112 which are the third antenna patch pair. Fourth micro-strip feed line 140 connects the seventh antenna patch 114 and the eighth antenna patch 116 which are the fourth antenna patch pair. Fifth micro-strip feed line 142 connects the ninth antenna patch 118 and the tenth antenna patch 120 which are the fifth antenna patch pair. Sixth micro-strip feed line 144 connects the eleventh antenna patch 122 and the twelfth antenna patch 124 which are the sixth antenna patch pair. Seventh micro-strip feed line 146 connects the thirteenth antenna patch 126 and the fourteenth antenna patch 128 which are the seventh antenna patch pair. Eighth micro-strip feed line 148 connects the fifteenth antenna patch 130 and the sixteenth antenna patch 132 which are the eight antenna patch pair.

The pairs of antenna patches in the embodiment in FIG. 1A are further connected to form antenna patch quads. Thus, for example, a first pair of two antennas connected to a second pair of two antennas forms a first quad of antennas.

The configuration uses a plurality of feed lines or trace lines to connect the patch antennas. The impedance of the trace line can be the same as the impedance of the patch antenna at an end of the form factor where the trace line is connected. Trace lines can be made of any impedance, provided that at the point where the connection to the patch antenna is made, the impedance is the same.

The first antenna pair connected by first micro-strip feed line 134 and the second antenna pair connected by the second micro-strip feed line 136 are further connected by ninth micro-strip feed line 150 and form a first antenna quad. The third antenna pair connected by the third micro-strip feed line 138 and the fourth antenna pair connected by the fourth micro-strip feed line 140 are further connected by tenth micro-strip feed line 152 and form a second antenna quad. The fifth antenna pair connected by fifth micro-strip feed line 142 and the sixth antenna pair connected by the sixth micro-strip feed line 144 are further connected by the eleventh micro-strip feed line 154 to form a third antenna quad. The seventh antenna pair connected by the seventh micro-strip feed line 146 and the eighth antenna pair connected by the eighth micro-strip feed line 148 are further connected by the twelfth micro-strip feed line 156 to form a fourth antenna quad.

The first antenna quad is connected to the second antenna quad via thirteenth micro-strip feed line 158 which connects the ninth micro-strip feed line 150 and the tenth micro-strip feed line 152. The third antenna quad is connected to the fourth antenna quad via fourteenth micro-strip feed line 160 which connects the eleventh micro-strip feed line 154 and the twelfth micro-strip feed line 156.

The thirteenth micro-strip feed line 158 and the fourteenth micro-strip feed line 160 are further connected by the fifteenth micro-strip feed line 162. The fifteenth micro-strip feed line 162 is connected to the output port 164, which may then be connected to external electronics, devices, systems, etc. Thus, signals from up to 16 patch antennas converge to a single output. Phase-shifters may be incorporated at two points on each micro-strip, enabling multi-phased output from the disclosed device.

The micro-strip traces or feed lines connecting the antenna patches, the antenna patch pairs, the antenna patch quads, and the antenna patch paired quads (e.g., eight patches), are illustrated with two parallel arms (illustrated as vertical in the figure) are connected by a perpendicular member (illustrated as horizontal) where the parallel arms are shorted than the perpendicular member, thus creating a square-bottomed U-shape with a connector extending from the bottom as shown. As will be appreciated by those skill in the art, other shapes can be used without departing from the scope of the disclosure including, but not limited to, rounded-bottom U-shape, V-shape, forked, etc.

The micro-strip feed lines form a feed network. The feed network allows the phase-shifting components to be integrated in any of the feed lines (e.g., any of the micro-strip feed lines). This allows each of the patch antennas in the antenna array to potentially be fed by a signal of a different phase. Alternately patch antennas in the antenna array may be grouped (e.g., in pairs, quads or pairs of quads), and each antenna group can them be fed by a signal with a different phase. This enables creation of a broad combined radiation pattern with relatively high gain, resulting in effective coverage. As discussed above, the phased array design with a wide radiation pattern in a first plane and a narrow radiation pattern in a second plane that is orthogonal to the first plane enables reliable signal-tracking and reduces the need for high signal power.

FIG. 1B illustrates ground plane 190 according to the disclosure, viewed from above. Ground plane 190 consists of a thin, rectangular copper sheet measuring from about 80 mm to about 130 mm, more preferably about 108 mm in a first dimension and from about 14 mm to about 22 mm in a second dimension, more preferably about 18 mm attached to the bottom surface of dielectric substrate 101 (FIG. 1A).

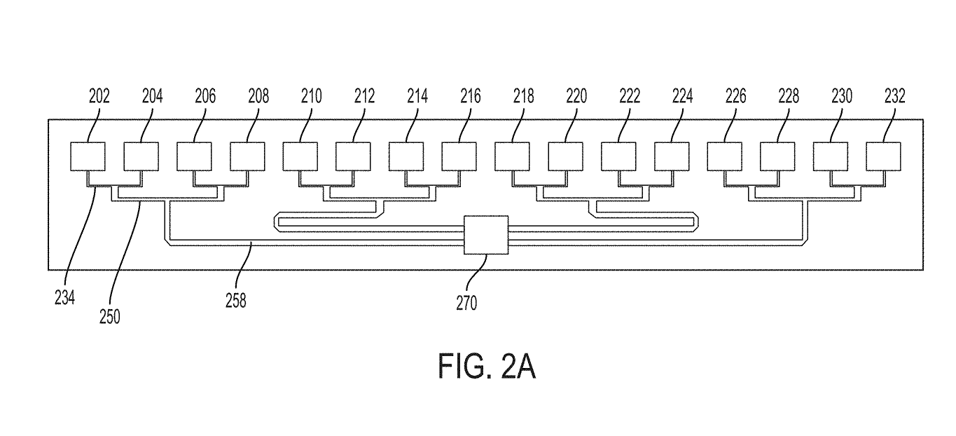

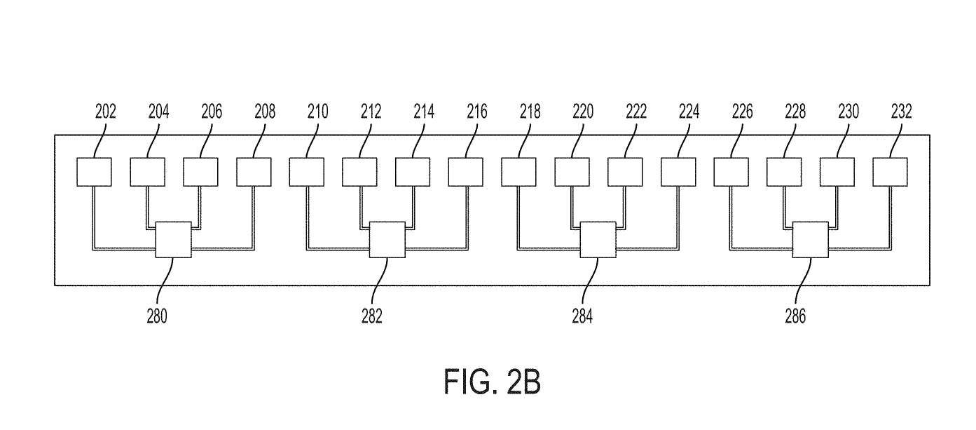

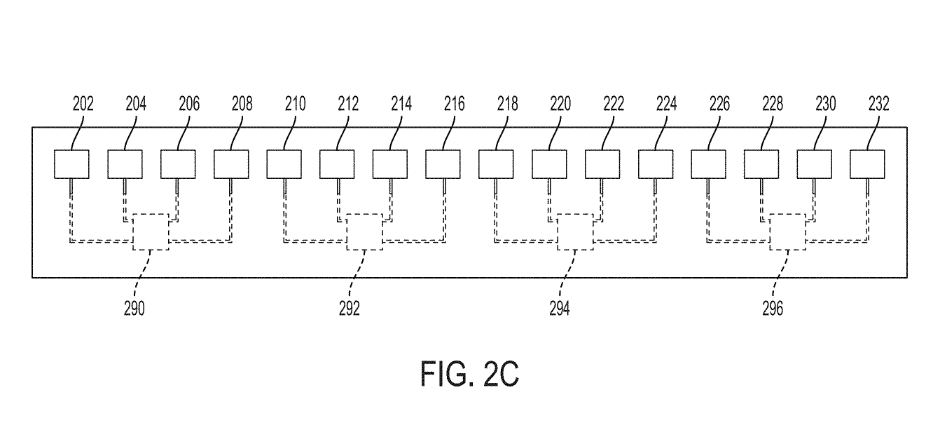

FIG. 2A illustrates a top view of an alternative embodiment of an antenna array according to the disclosure. A plurality of antenna patches are provided illustrated as a first antenna patch 202, a second antenna patch 204, a third antenna patch 206, a fourth antenna patch 208, a fifth antenna patch 210, a sixth antenna patch 212, a seventh antenna patch 214, an eighth antenna patch 216, a ninth antenna patch 218, a tenth antenna patch 220, an eleventh antenna patch 222, a twelfth antenna patch 224, a thirteenth antenna patch 226, a fourteenth antenna patch 228, a fifteenth antenna patch 230, and a sixteenth antenna patch 232. In the configuration illustrated in FIG. 2A, a plurality of feed lines 234, 250, 258 are shown which connect the antenna patches in pairs and quad and then output the connected antenna patches to a radio frequency integrated circuit (RFIC) 270. The RFIC 270 contains a plurality of components including, but not limited to one or more of phase shifters, amplifiers and control logic. The RFIC is configurable to have 4 RD out pins, e.g., 4 phase shifters. Each antenna patch can be controlled by one phase shifter. In some configurations, the RFIC 270 can be connected to an output port or any other suitable output connector, such as a female SubMiniature version A connector.

FIG. 2B illustrates a top view of an alternative embodiment of an antenna array according to the disclosure. A plurality of antenna patches are provided illustrated as a first antenna patch 202, a second antenna patch 204, a third antenna patch 206, a fourth antenna patch 208, a fifth antenna patch 210, a sixth antenna patch 212, a seventh antenna patch 214, an eighth antenna patch 216, a ninth antenna patch 218, a tenth antenna patch 220, an eleventh antenna patch 222, a twelfth antenna patch 224, a thirteenth antenna patch 226, a fourteenth antenna patch 228, a fifteenth antenna patch 230, and a sixteenth antenna patch 232. In the configuration illustrated in FIG. 2B, a plurality of feed lines are shown which connect the four antenna patches to a plurality of RFIC 280, 282, 284, 286.

FIG. 2C illustrates a top view of an alternative embodiment of an antenna array according to the disclosure. A plurality of antenna patches are provided illustrated as a first antenna patch 202, a second antenna patch 204, a third antenna patch 206, a fourth antenna patch 208, a fifth antenna patch 210, a sixth antenna patch 212, a seventh antenna patch 214, an eighth antenna patch 216, a ninth antenna patch 218, a tenth antenna patch 220, an eleventh antenna patch 222, a twelfth antenna patch 224, a thirteenth antenna patch 226, a fourteenth antenna patch 228, a fifteenth antenna patch 230, and a sixteenth antenna patch 232. In the configuration illustrated in FIG. 2C, a plurality of feed lines are shown in dashed lines which connect the four antenna patches on a first surface to a plurality of RF IC 280, 282, 284, 286 on a second surface (also shown in dashed lines). As illustrated in FIG. 2C the phase shifters can be places on the opposite side of the PCB and connected with vias to the top side where the antenna patches are positioned.

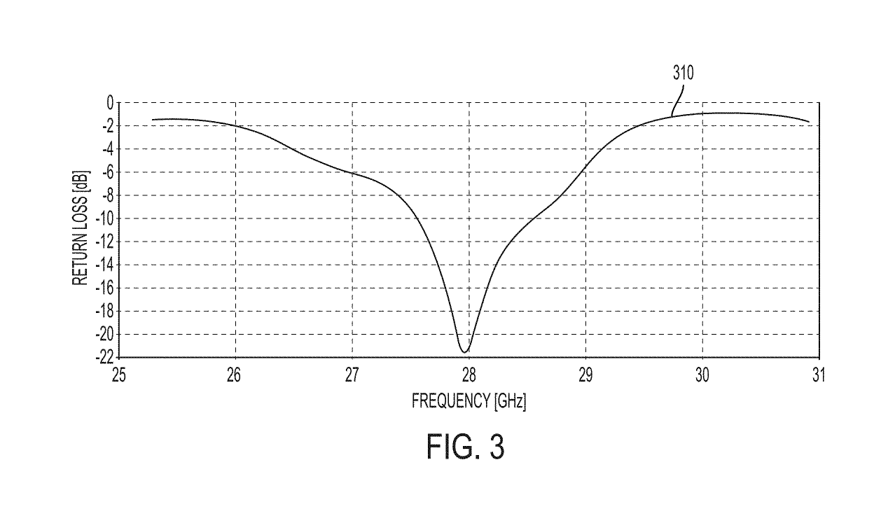

FIG. 3 is a plot of simulated return loss of a 16×1 linear patch antenna array from 25 GHz to 31 GHz that models return loss of the disclosure. The trace on the plot represents simulated system return loss 310. In the region from 27.5 GHz to 28.5 GHz, the return loss values range from approximately −8.9 dB at 27.5 GHz, decreasing monotonically to a minimum value of approximately −21.5 dB at approximately 27.95 GHz, and then increasing monotonically to a value of approximately −10.4 dB at 28.5 GHz.

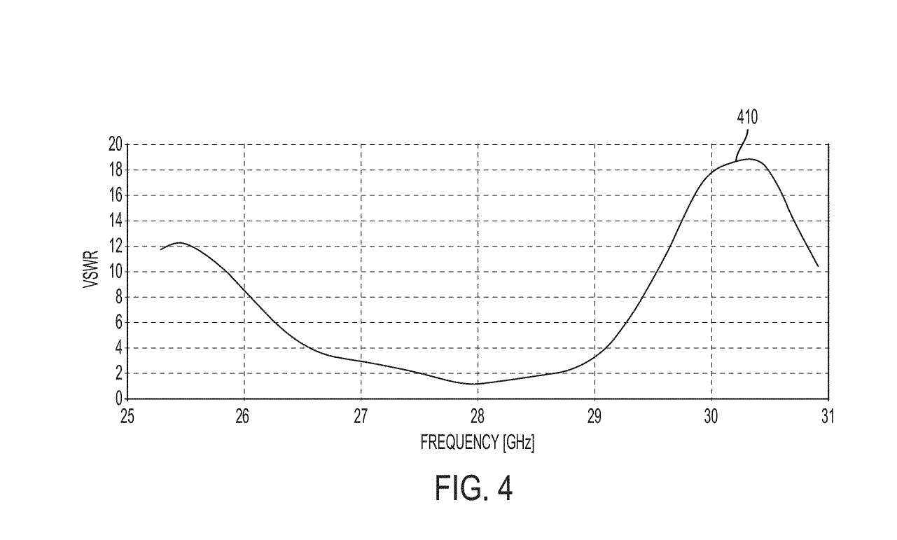

FIG. 4 is a plot of simulated VSWR of a 16×1 linear patch antenna array from 25 GHz to 31 GHz that models VSWR of the disclosure. The trace on the plot represents simulated VSWR 410 of the antenna array. In the region from 27.5 GHz to 28.5 GHz, the VSWR values range from approximately 2.1 at 27.5 GHz, decreasing monotonically to a minimum value of approximately 1.5 at approximately 27.95 GHz, and then increasing monotonically to a value of approximately 1.9 at 28.5 GHz. As will be appreciated by those skilled in the art, the detailed description of the RL and VSVR efficiency, for example, is provided to illustrate performance. With different feed networks and different numbers of phase shifters, these performance characteristics will change. Consequently, the antenna is well matched between 27 GHz and 29 GHz.

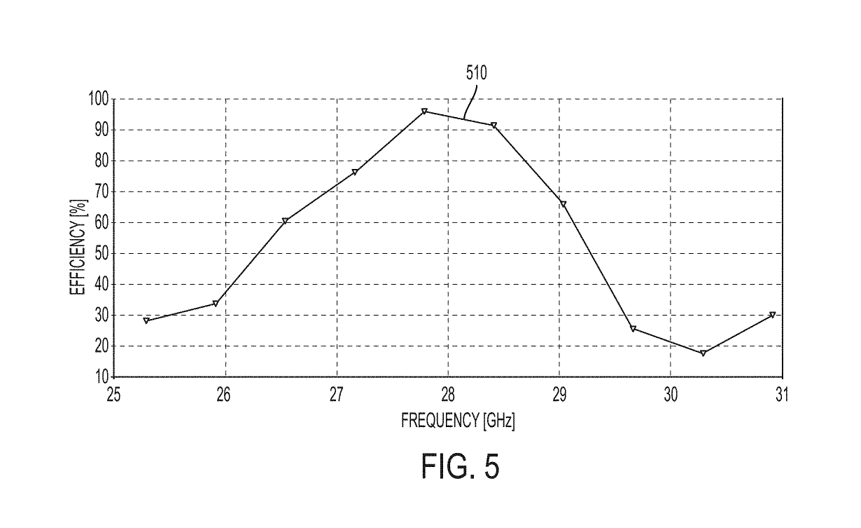

FIG. 5 is a plot of simulated efficiency of a 16×1 linear patch antenna array from 25 GHz to 31 GHz that models efficiency of the disclosure. The trace on the plot represents simulated array antenna efficiency 510. In the region from 27.5 GHz to 28.5 GHz, the efficiency values range from approximately 87% at 27.5 GHz, increasing monotonically to a maximum value of approximately 96% at approximately 27.8 GHz, and then decreasing monotonically to a value of approximately 86% at 28.5 GHz.

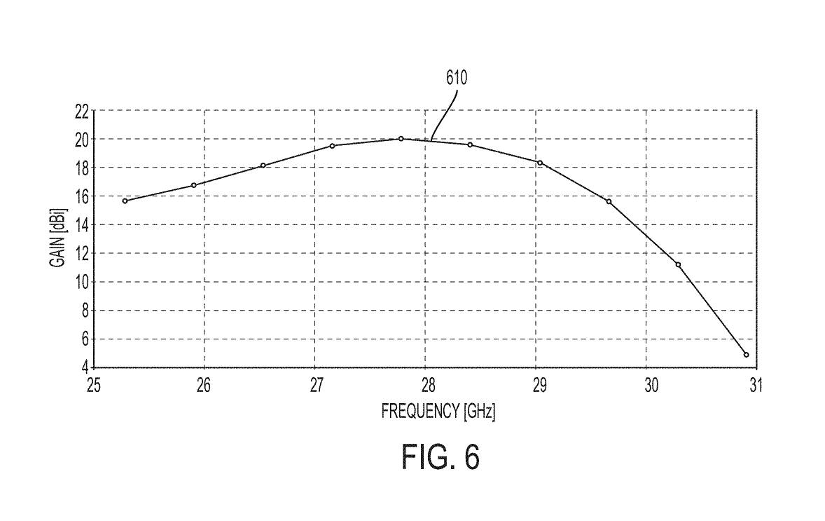

FIG. 6 is a plot of simulated peak gain of a 16×1 linear patch antenna array from 25 GHz to 31 GHz that models peak gain of the disclosure. The trace on the plot represents simulated system peak gain 610. In the region from 27.5 GHz to 28.5 GHz, the peak gain values range from approximately 19.7 dB at 27.5 GHz, increasing monotonically to a maximum value of approximately 20 dB at approximately 27.8 GHz, and then decreasing monotonically to a value of approximately 19.4 dB at 28.5 GHz.

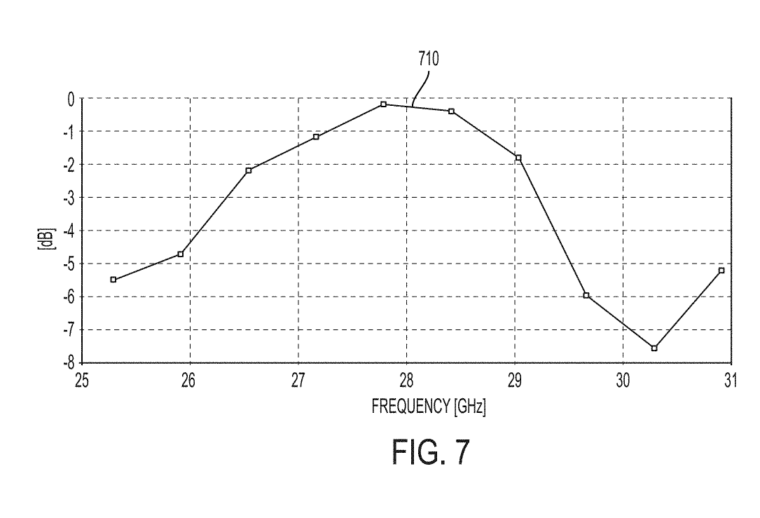

FIG. 7 is a plot of simulated average gain of a 16×1 linear patch antenna array from 25 GHz to 31 GHz that models peak gain of the disclosure. The trace on the plot represents simulated system average gain 710. In the region from 27.5 GHz to 28.5 GHz, the average gain values range from approximately −0.7 dB at 27.5 GHz, increasing monotonically to a maximum value of approximately −0.2 dB at approximately 27.8 GHz, and then decreasing monotonically to a value of approximately −0.4 dB at 28.5 GHz.

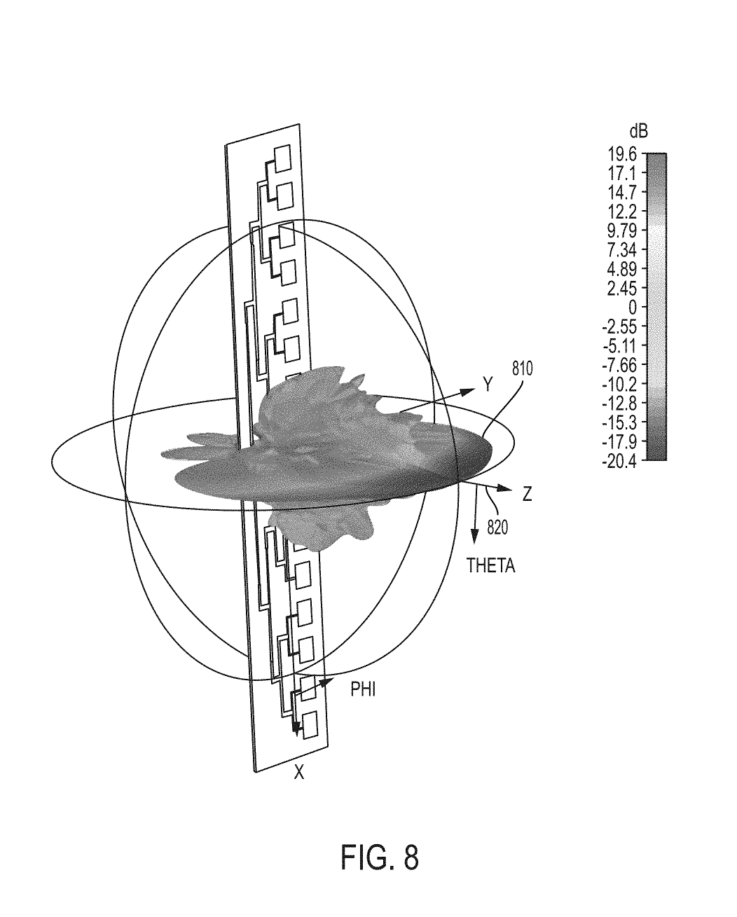

FIG. 8 is a three-dimensional plot of the simulated radiation pattern of the disclosed device at a frequency of 28 GHz. The pattern on the plot represents the simulated radiation pattern 810 of the disclosed antenna system. Note the high peak gain of approximately 20 dB; the wide azimuthal coverage in the x-y plane of reference coordinate system 820; and the relatively narrow coverage along the z-axis of reference coordinate system 820. This radiation pattern simulates the radiation pattern of each patch antenna in the disclosure.

In the embodiment depicted in FIG. 1A and FIG. 1B, the size of the patch antennas, distance between them and details of the feed network are designed so that a phase shifter may be integrated in one or more of the micro-strip lines, changing the phase of the signal fed to the antenna or group of the antennas and altering the shape and direction of the radiation pattern for those antennas.

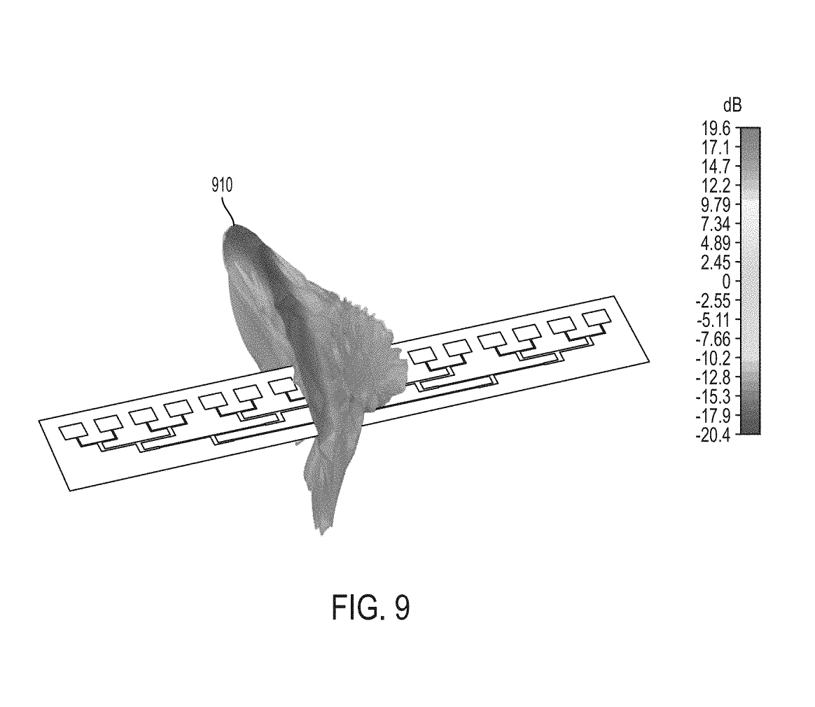

FIG. 9 is a three-dimensional plot of the simulated radiation pattern of the disclosed device at a frequency of 28 GHz with a 75 degree phase shift applied. The pattern on the plot represents the simulated 75-degree, phase-shifted radiation pattern 910 of the disclosed antenna system. Note that while peak gain and azimuthal coverage are similar to those of the simulated radiation pattern in FIG. 8, the shape and direction differ substantially.

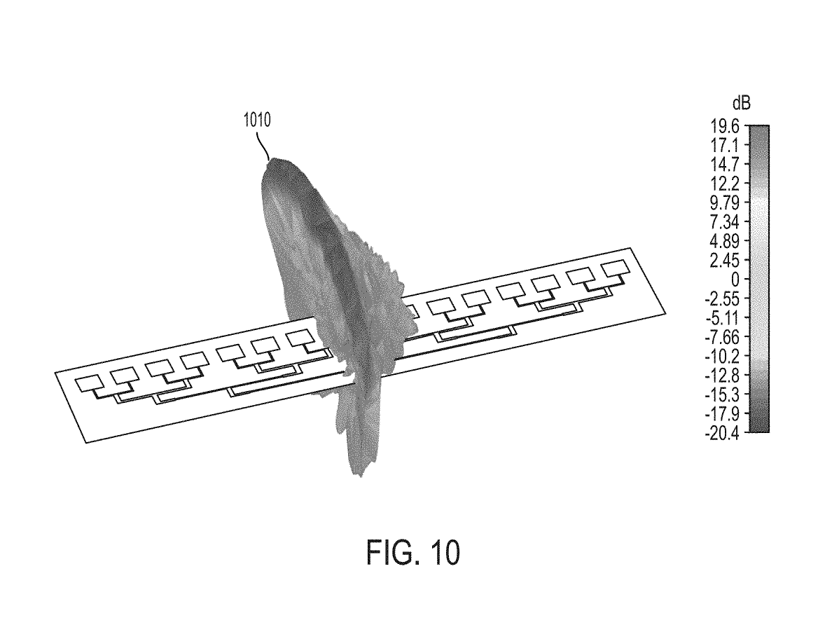

FIG. 10 is a three-dimensional plot of the simulated radiation pattern of the disclosed device at a frequency of 28 GHz with a 45 degree phase shift applied. The pattern on the plot represents the simulated 45-degree, phase-shifted radiation pattern 1010 of the disclosed antenna system. Note that while peak gain and azimuthal coverage are similar to those of the simulated radiation pattern in FIG. 8, the shape and direction differ substantially.

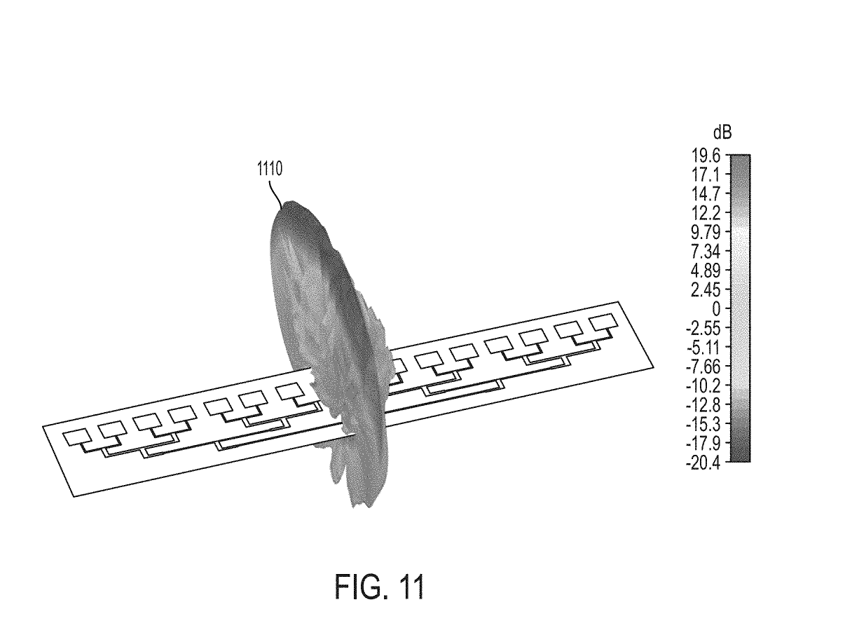

FIG. 11 is a three-dimensional plot of the simulated radiation pattern of the disclosed device at a frequency of 28 GHz with a 15 degree phase shift applied. The pattern on the plot represents the simulated 15-degree, phase-shifted radiation pattern 1110 of the disclosed antenna system. Note that while peak gain and azimuthal coverage are similar to those of the simulated radiation pattern in FIG. 8, the shape and direction differ somewhat.

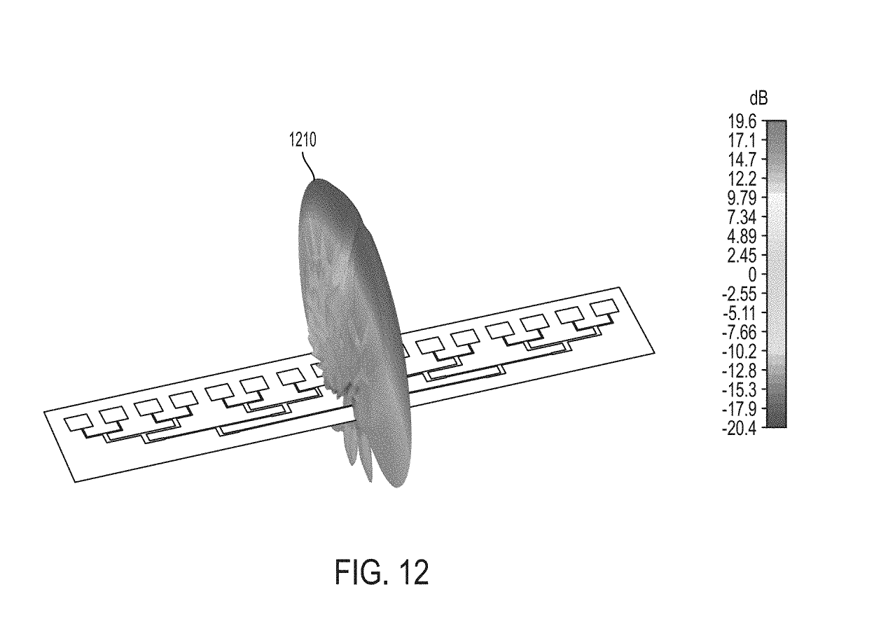

FIG. 12 is a three-dimensional plot of the simulated radiation pattern of the disclosed device at a frequency of 28 GHz with no phase shift. The pattern on the plot represents the simulated 0-degree, phase-shifted radiation pattern 1210 of the disclosed antenna system. Note that peak gain and azimuthal coverage and simulated radiation pattern are identical to those in FIG. 8.

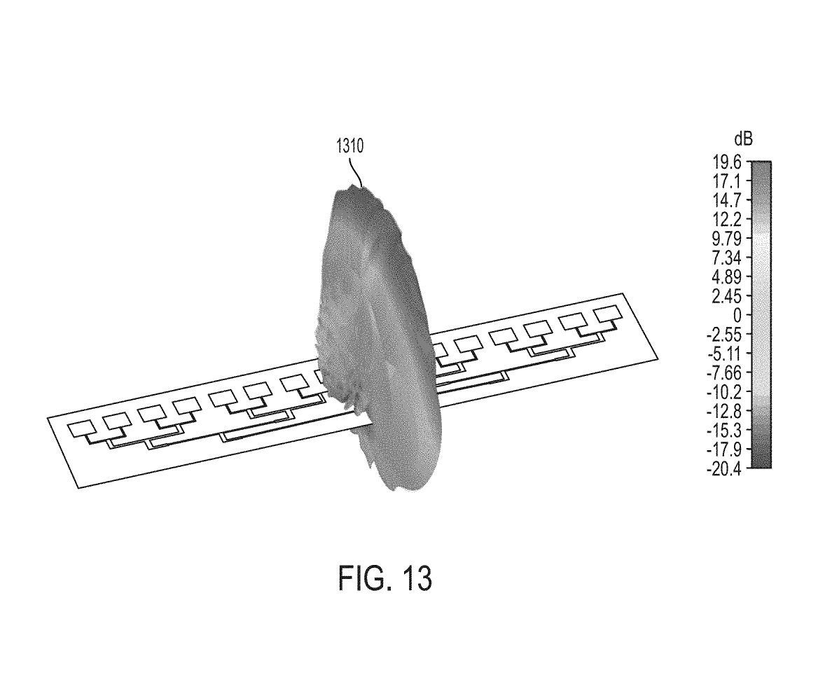

FIG. 13 is a three-dimensional plot of the simulated radiation pattern of the disclosed device at a frequency of 28 GHz with a −15 degree phase shift applied. The pattern on the plot represents the simulated minus-15-degree, phase-shifted radiation pattern 1310 of the disclosed antenna system. Note that while peak gain and azimuthal coverage are similar to those of the simulated radiation pattern in FIG. 8, the shape and direction differ somewhat. Note also that the minus-15-degree, phase-shifted radiation pattern 1310 is the mirror image of 15-degree, phase-shifted radiation pattern 1110.

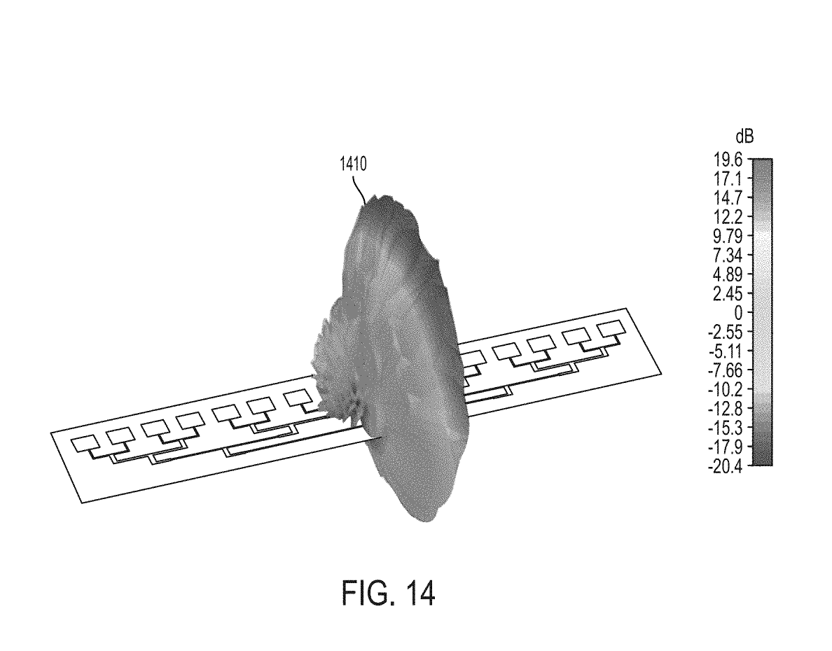

FIG. 14 is a three-dimensional plot of the simulated radiation pattern of the disclosed device at a frequency of 28 GHz with a −45 degree phase shift applied. The pattern on the plot represents the simulated minus-45-degree, phase-shifted radiation pattern 1410 of the disclosed antenna system. Note that while peak gain and azimuthal coverage are similar to those of the simulated radiation pattern in FIG. 8, the shape and direction differ significantly. Note also that the minus-45-degree, phase-shifted radiation pattern 1410 is the mirror image of 45-degree, phase-shifted radiation pattern 1010.

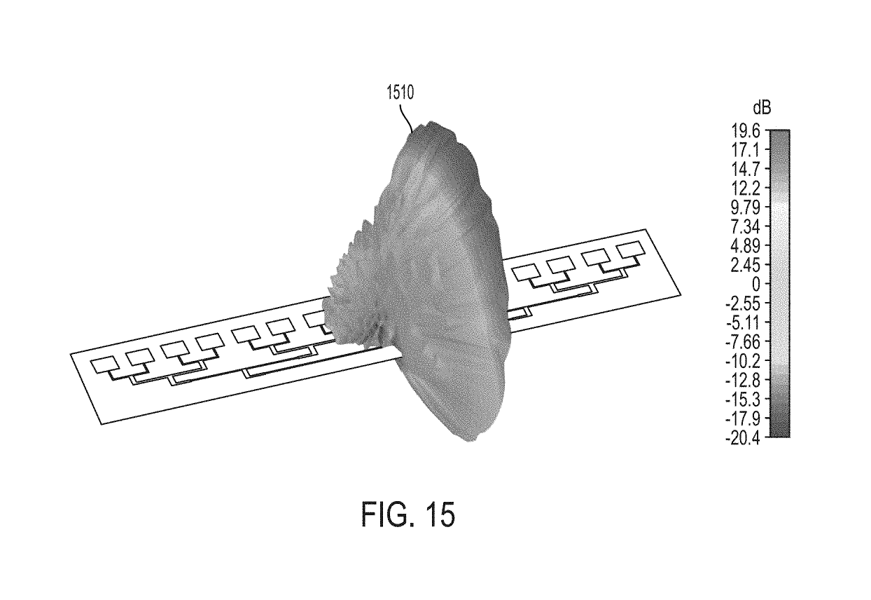

FIG. 15 is a three-dimensional plot of the simulated radiation pattern of the disclosed device at a frequency of 28 GHz with a −75 degree phase shift applied. The pattern on the plot represents the simulated minus-75-degree, phase-shifted radiation pattern 1510 of the disclosed antenna system. Note that while peak gain and azimuthal coverage are similar to those of the simulated radiation pattern in FIG. 8, the shape and direction differ significantly. Note also that the minus-75-degree, phase-shifted radiation pattern 1510 is the mirror image of 75-degree, phase-shifted radiation pattern 910.

By strategically integrating a number of different phase shifters in a number of the micro-strip lines, thus changing the phase of the signal fed to the antenna or group of the antennas and altering the shape and direction of the radiation pattern for those antennas, a much broader radiation pattern may be established for the disclosed antenna system than would be available via any single antenna.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A 27.5-28.5 GHz Ka band phased array fan beam antenna comprising:
a substrate;
a first antenna patch connected to a second antenna patch by a first micro-strip feed line to form a first antenna patch pair;
a third antenna patch connected to a fourth antenna patch by a second micro-strip feed line to form a second antenna patch pair;
a fifth antenna patch connected to a sixth antenna patch by a third micro-strip feed line to form a third antenna patch pair;
a seventh antenna patch connected to an eighth antenna patch by a fourth micro-strip feed line to form a fourth antenna patch pair; and
an output port,
wherein the first antenna patch pair is connected to the second antenna patch to form a first antenna patch quad via a first micro-strip quad connector and the third antenna patch pair is connected to the fourth antenna patch pair to form a second antenna patch quad via a second micro-strip quad connector, and further wherein the first micro-strip quad connector and the second micro-strip quad connector are connected to the output port.

2. The 27.5-28.5 GHz Ka band phased array fan beam antenna of claim 1 further comprising:
a ninth antenna patch connected to a tenth antenna patch by a fifth micro-strip feed line to form a fifth antenna patch pair;
an eleventh antenna patch connected to a twelfth antenna patch by a sixth micro-strip feed line to form a sixth antenna patch pair;
a thirteenth antenna patch connected to a fourteenth antenna patch by a seventh micro-strip feed line to form a seventh antenna patch pair;
a fifteenth antenna patch connected to a sixteenth antenna patch by an eighth micro-strip feed line to form an eighth antenna patch pair,
wherein the fifth antenna patch pair is connected to the sixth antenna patch to form a third antenna patch quad via a third micro-strip quad connector and the seventh antenna patch pair is connected to the eighth antenna patch pair to form a fourth antenna patch quad via a forth micro-strip quad connector, and further wherein the third micro-strip quad connector and the fourth micro-strip quad connector are connected to the output port.

3. The 27.5-28.5 GHz Ka band phased array fan beam antenna of claim 1 wherein one or more of the first patch antenna, second patch antenna, third patch antenna, fourth patch antenna, fifth patch antenna, sixth patch antenna, seventh patch antenna and eight patch antenna have a shape selected from square, round, rectangular, oval, ovoid and triangular.

4. The 27.5-28.5 GHz Ka band phased array fan beam antenna of claim 2 wherein one or more of the ninth patch antenna, tenth patch antenna, eleventh patch antenna, twelfth patch antenna, thirteenth patch antenna, fourteenth patch antenna, fifteenth patch antenna and sixteenth patch antenna have a shape selected from square, round, rectangular, oval, ovoid and triangular.

5. The 27.5-28.5 GHz Ka band phased array fan beam antenna of claim 1 wherein one or more of the first micro-strip feed line, second micro-strip feed line, third micro-strip feed line, and fourth micro-strip feed line have a shape selected from U-shaped, V-shaped and forked and further comprise a connector.

6. The 27.5-28.5 GHz Ka band phased array fan beam antenna of claim 2 wherein one or more of the fifth micro-strip feed line, sixth micro-strip feed line, seventh micro-strip feed line, and eighth micro-strip feed line have a shape selected from U-shaped, V-shaped and forked and further comprise a connector.

7. The 27.5-28.5 GHz Ka band phased array fan beam antenna of claim 1 wherein one or more of the first micro-quad connector, and the second micro-strip quad connector have a shape selected from U-shaped, V-shaped and forked and further comprise a connector.

8. The 27.5-28.5 GHz Ka band phased array fan beam antenna of claim 2 wherein one or more of the third micro-quad connector, and the fourth micro-strip quad connector have a shape selected from U-shaped, V-shaped and forked and further comprise a connector.

9. The 27.5-28.5 GHz Ka band phased array fan beam antenna of claim 2 wherein one or more of the first micro-quad connector, and the second micro-strip quad connector have a shape selected from U-shaped, V-shaped and forked and further comprise a connector.

10. The 27.5-28.5 GHz Ka band phased array fan beam antenna of claim 1 wherein one or more of the first micro-strip feed line, second micro-strip feed line, third micro-strip feed line, and fourth micro-strip feed line have a pair of phase-shifting components integrated therein.

11. The 27.5-28.5 GHz Ka band phased array fan beam antenna of claim 2 wherein one or more of the fifth micro-strip feed line, sixth micro-strip feed line, seventh micro-strip feed line, and eighth micro-strip feed line have a pair of phase-shifting components integrated therein.

12. A method of generating a 27.5-28.5 GHz Ka band phased array from a fan beam antenna comprising:
providing a substrate with a plurality of antenna patches connected by a plurality of feed lines forming a feed network;
feeding a signal of a different phase to at least one of the plurality of antenna patches; and
creating a broad radiation pattern with a high gain in a first plane and a narrow radiation in a second plane orthogonal to the first plane.

13. The method of generating a 27.5-28.5 GHz Ka band phased array from a fan beam antenna of claim 12 further comprising sixteen antenna patches.

14. The method of generating a 27.5-28.5 GHz Ka band phased array from a fan beam antenna of claim 12 further comprising more than four pairs of antenna patches.

15. The method of generating a 27.5-28.5 GHz Ka band phased array from a fan beam antenna of claim 14 wherein each pair of antenna patches is connected by a corresponding feed line.

16. The method of generating a 27.5-28.5 GHz Ka band phased array from a fan beam antenna of claim 15 wherein each connected pair of antenna patches is connected by a feed line.

17. The method of generating a 27.5-28.5 GHz Ka band phased array from a fan beam antenna of claim 12 further comprising one or more integrated circuits on the substrate wherein each integrated circuit of the one or more integrated circuits is connected to one or more of the plurality of antenna patches.

18. A 27.5-28.5 GHz Ka band phased array fan beam antenna comprising:
a substrate;
a plurality of antenna patches,
a plurality of micro-strip feed lines; and
at least one of an output port and at least one integrated circuit,
wherein the plurality of micro-strip feed lines connect one or more of the plurality of antenna patches to at least one of another antenna patch, the output port and the integrated circuit.

19. The 27.5-28.5 GHz Ka band phased array fan beam antenna of claim 18 wherein one or more of the plurality of patch antennas has a shape selected from square, round, rectangular, oval, ovoid and triangular.

20. The 27.5-28.5 GHz Ka band phased array fan beam antenna of claim 18 wherein one or more of the plurality of micro-strip feed lines has a shape selected from U-shaped, V-shaped and forked and further comprises a connector.

21. The 27.5-28.5 GHz Ka band phased array fan beam antenna of claim 18 wherein one or more of the plurality of micro-strip feed lines have a pair of phase-shifting components integrated therein.
